(19) United States
(12) Patent Application Publication
(10) Pub. No.: US 2026/0301210 A1
(43) Pub. Date: Oct. 1, 2026

(54) TOP VIEW FISH CHARACTERISTIC DETERMINATION

(71) Applicant: InnovaSea Systems, Inc., Boston, MA (US)

(72) Inventors: Kartik MADHIRA, Framingham, MA (US); Srikanth PARUPATI, Cumming, GA (US)

(73) Assignee: InnovaSea Systems, Inc., Boston, MA (US)

(21) Appl. No.: 19/575,111

(22) Filed: Mar. 23, 2026

Related U.S. Application Data
(60) Provisional application No. 63/778,525, filed on Mar. 27, 2025.

(51) Int. Cl. G06T 7/60; G06T 7/12; G06T 7/70; G06V 20/05; G06V 40/10

(52) U.S. Cl. CPC G06T 7/60; G06T 7/12; G06T 7/70; G06V 20/05; G06V 40/10; G06T 2207/10012

(57) ABSTRACT

Techniques for top view fish characteristic determination are described. A stereo camera captures a stereo (e.g., left and right) image pair of water located below the stereo camera. An image of the pair may thereafter be processed to generate a corresponding undistorted image that is processed to identify a body boundary (i.e., excluding a tail portion) of a fish therein. The body boundary may be used to estimate a fork length of the fish, and the body boundary and estimated fork length may be used to determine one or more characteristics (e.g., weight and/or overall length) of the fish. The fish characteristic(s) can be used to estimate the biomass in the water below the stereo camera.

### BACKGROUND

Underwater fish biomass estimation cameras are an important tool in fin-fish aquaculture production, providing insights into fish health and growth rates with minimal impact. This technology involves various methods to estimate and calculate the mass of living organisms in an underwater location.

Techniques, like acoustic biomass estimation, use sonar to detect and quantify fish populations, while optical methods, including underwater photography and videography, enable direct observation and measurement of fish. Advanced methods may also incorporate remote sensing and satellite data, alongside in-situ sampling, to estimate biomass over larger scales. These technologies are beneficial for sustainable fisheries management, conservation efforts, and understanding the impacts of climate change on marine ecosystems.

The use of visual underwater technology has increased in recent years due to relatively inexpensive capital equipment costs compared to other techniques and the advancement of deep learning in computer vision. Biomass estimation cameras are highly accurate in estimating the biomass of fish population in open ocean, however they encounter difficulties when solids are present. This may include organic particulates as a result from plankton, algal blooms, fecal matter, and microbial activity. Inorganic suspended solids in water may be caused by resuspension of sediments from land-based water runoff because of rainfall, from streams or rivers entering a body of water where aquaculture is practiced, or from raising fish in riverine environments. Recirculating Aquaculture System (RAS), dams, ponds, lakes, and tanks are also often subject to water clarity issues (e.g., due to high turbidity as a result of suspended organic solids) that limit the use of underwater machine visioning techniques to image fish for the purpose of assessing health and biomass. Water clarity may also be affected from different disinfectant procedures, such as the use of ozone.

### SUMMARY

A first aspect of the present disclosure relates to a system comprising: at least one processor; and at least one memory comprising instructions that, when executed by the at least one processor, cause the system to: receive image data from a stereo camera positioned above water, the image data comprising left image data and right image data associated with a same timestamp; determine undistorted image data from one of the left or right image data; determine a body boundary of a fish in the undistorted image data, the body boundary excluding a tail portion of the fish; determine, using the body boundary, an estimated fork length of the fish; and determine at least one characteristic of the fish using the body boundary and the estimated fork length.

In some embodiments of the first aspect, a lens of the stereo camera is oriented parallel to a surface of the water.

In some embodiments of the first aspect, a lens of the stereo camera is offset up to 20° from perpendicular with respect to a surface of the water.

In some embodiments of the first aspect, the image data is captured during a feeding time of fish in the water.

In some embodiments of the first aspect, the system further determines the undistorted image data by, for each coordinate pair in one of the left or right image data, determine a corrected coordinate pair using a distance between a lens of the stereo camera and a surface of the water, the refractive index of air, and the refractive index of water.

In some embodiments of the first aspect, the system further determines, using the body boundary, that the fish has a linear orientation; and determines the estimated fork length based on the fish having the linear orientation.

In some embodiments of the first aspect, the system further determines a second body boundary of a second fish in the undistorted image data, the second body boundary excluding a tail portion of the second fish; determines, using the second body boundary, that the second fish has a curved orientation; and refrains from determining a second estimated fork length for the second fish based on the second fish having the curved orientation.

In some embodiments of the first aspect, the system further determines, using the body boundary, that the fish has a curved orientation; after determining the fish has a curved orientation, determines a linear orientation for the fish; and determines the estimated fork length using the linear orientation.

In some embodiments of the first aspect, the system further determines distal endpoints of the body boundary; and determines the estimated fork length using the distal endpoints.

In some embodiments of the first aspect, the system further determines a corrected estimated fork length using the estimated fork length and a length factor; and determines the at least one characteristic of the fish using the body boundary and the corrected estimated fork length.

In some embodiments of the first aspect, the length factor is selected based on a species of the fish.

In some embodiments of the first aspect, the system further determines the length factor based on corresponding side view and top view image data of a plurality of fish corresponding to a same species.

In some embodiments of the first aspect, the system further determines, within the body boundary, a portion of the fish having a shortest distance to the stereo camera; determines the shortest distance is no farther than a threshold distance; and determines the estimated fork length in response to the shortest distance being no farther than the threshold distance.

In some embodiments of the first aspect, the threshold distance is 10 cm.

In some embodiments of the first aspect, the at least one characteristic comprises at least one of a weight and an overall length of the fish.

A second aspect of the present disclosure relates to a device comprising: at least one processor; and at least one memory comprising instructions that, when executed by the at least one processor, cause the device to: receive image data from a stereo camera positioned above water, the image data comprising left image data and right image data associated with a same timestamp; determine undistorted image data from one of the left or right image data; determine a body boundary of a fish in the undistorted image data, the body boundary excluding a tail portion of the fish; determine, using the body boundary, an estimated fork length of the fish; and determine at least one characteristic of the fish using the body boundary and the estimated fork length.

In some embodiments of the second aspect, a lens of the stereo camera is oriented parallel to a surface of the water.

In some embodiments of the second aspect, a lens of the stereo camera is offset up to 20° from perpendicular with respect to a surface of the water.

In some embodiments of the second aspect, the image data is captured during a feeding time of fish in the water.

In some embodiments of the second aspect, the device further determines the undistorted image data by, for each coordinate pair in one of the left or right image data, determine a corrected coordinate pair using a distance between a lens of the stereo camera and a surface of the water, the refractive index of air, and the refractive index of water.

In some embodiments of the second aspect, the device further determines, using the body boundary, that the fish has a linear orientation; and determines the estimated fork length based on the fish having the linear orientation.

In some embodiments of the second aspect, the device further determines a second body boundary of a second fish in the undistorted image data, the second body boundary excluding a tail portion of the second fish; determines, using the second body boundary, that the second fish has a curved orientation; and refrains from determining a second estimated fork length for the second fish based on the second fish having the curved orientation.

In some embodiments of the second aspect, the device further determines, using the body boundary, that the fish has a curved orientation; after determining the fish has a curved orientation, determines a linear orientation for the fish; and determines the estimated fork length using the linear orientation.

In some embodiments of the second aspect, the device further determines distal endpoints of the body boundary; and determines the estimated fork length using the distal endpoints.

In some embodiments of the second aspect, the device further determines a corrected estimated fork length using the estimated fork length and a length factor; and determines the at least one characteristic of the fish using the body boundary and the corrected estimated fork length.

In some embodiments of the second aspect, the length factor is selected based on a species of the fish.

In some embodiments of the second aspect, the device further determines the length factor based on corresponding side view and top view image data of a plurality of fish corresponding to a same species.

In some embodiments of the second aspect, the device further determines, within the body boundary, a portion of the fish having a shortest distance to the stereo camera; determines the shortest distance is no farther than a threshold distance; and determines the estimated fork length in response to the shortest distance being no farther than the threshold distance.

In some embodiments of the second aspect, the threshold distance is 10 cm.

In some embodiments of the second aspect, the at least one characteristic comprises at least one of a weight and an overall length of the fish.

A third aspect of the present disclosure relates to a computer-implemented method comprising: receiving image data from a stereo camera positioned above water, the image data comprising left image data and right image data associated with a same timestamp; determining undistorted image data from one of the left or right image data; determining a body boundary of a fish in the undistorted image data, the body boundary excluding a tail portion of the fish; determining, using the body boundary, an estimated fork length of the fish; and determining at least one characteristic of the fish using the body boundary and the estimated fork length.

In some embodiments of the third aspect, a lens of the stereo camera is oriented parallel to a surface of the water.

In some embodiments of the third aspect, a lens of the stereo camera is offset up to 20° from perpendicular with respect to a surface of the water.

In some embodiments of the third aspect, the image data is captured during a feeding time of fish in the water.

In some embodiments of the third aspect, the computer-implemented method further comprises determining the undistorted image data by, for each coordinate pair in one of the left or right image data, determine a corrected coordinate pair using a distance between a lens of the stereo camera and a surface of the water, the refractive index of air, and the refractive index of water.

In some embodiments of the third aspect, the computer-implemented method further comprises determining, using the body boundary, that the fish has a linear orientation; and determining the estimated fork length based on the fish having the linear orientation.

In some embodiments of the third aspect, the computer-implemented method further comprises determining a second body boundary of a second fish in the undistorted image data, the second body boundary excluding a tail portion of the second fish; determining, using the second body boundary, that the second fish has a curved orientation; and refraining from determining a second estimated fork length for the second fish based on the second fish having the curved orientation.

In some embodiments of the third aspect, the computer-implemented method further comprises determining, using the body boundary, that the fish has a curved orientation; after determining the fish has a curved orientation, determining a linear orientation for the fish; and determining the estimated fork length using the linear orientation.

In some embodiments of the third aspect, the computer-implemented method further comprises determining distal endpoints of the body boundary; and determining the estimated fork length using the distal endpoints.

In some embodiments of the third aspect, the computer-implemented method further comprises determining a corrected estimated fork length using the estimated fork length and a length factor; and determining the at least one characteristic of the fish using the body boundary and the corrected estimated fork length.

In some embodiments of the third aspect, the length factor is selected based on a species of the fish.

In some embodiments of the third aspect, the computer-implemented method further comprises determining the length factor based on corresponding side view and top view image data of a plurality of fish corresponding to a same species.

In some embodiments of the third aspect, the computer-implemented method further comprises determining, within the body boundary, a portion of the fish having a shortest distance to the stereo camera; determining the shortest distance is no farther than a threshold distance; and determining the estimated fork length in response to the shortest distance being no farther than the threshold distance.

In some embodiments of the third aspect, the threshold distance is 10 cm.

In some embodiments of the third aspect, the at least one characteristic comprises at least one of a weight and an overall length of the fish.

### BRIEF DESCRIPTION OF DRAWINGS

FIG. 1 is a conceptual diagram illustrating a system for top view fish characteristic determination.

FIG. 2 is an example image, of a stereo image pair, captured using a stereo camera positioned within turbid water with low visibility.

FIG. 3 illustrates a point P being refracted to an image sensor plan as P′. P is the distance between the sensor plane and the water's surface.

FIG. 4 illustrates stereo camera coordinates X_{rc} and Y_{rc} of point P after refraction is accounted for.

FIG. 5 is a side view of a fish illustrating the fish's standard length (SL), fork length (FL), and total length (TL).

FIG. 6 is an image containing an annotation mask (i.e., body boundary) outlining the body (excluding the tail) of a fish.

FIG. 7 is a process flow diagram illustrating an example method performable by a fork length estimation component.

FIG. 8 is a block diagram conceptually illustrating example components of a system component.

### DETAILED DESCRIPTION

The present disclosure provides, among other things, top view fish characteristic determination techniques. A stereo camera captures a stereo (e.g., left and right) image pair of water located below the stereo camera. An image of the pair may thereafter be processed to generate a corresponding undistorted image that is processed to identify a body boundary (i.e., excluding a tail portion) of a fish therein. The body boundary may be used to estimate a fork length of the fish, and the body boundary and estimated fork length may be used to determine one or more characteristics (e.g., weight and/or overall length) of the fish. The fish characteristic(s) can be used to estimate the biomass in the water below the stereo camera.

### Top View Fish Characteristic Determination System

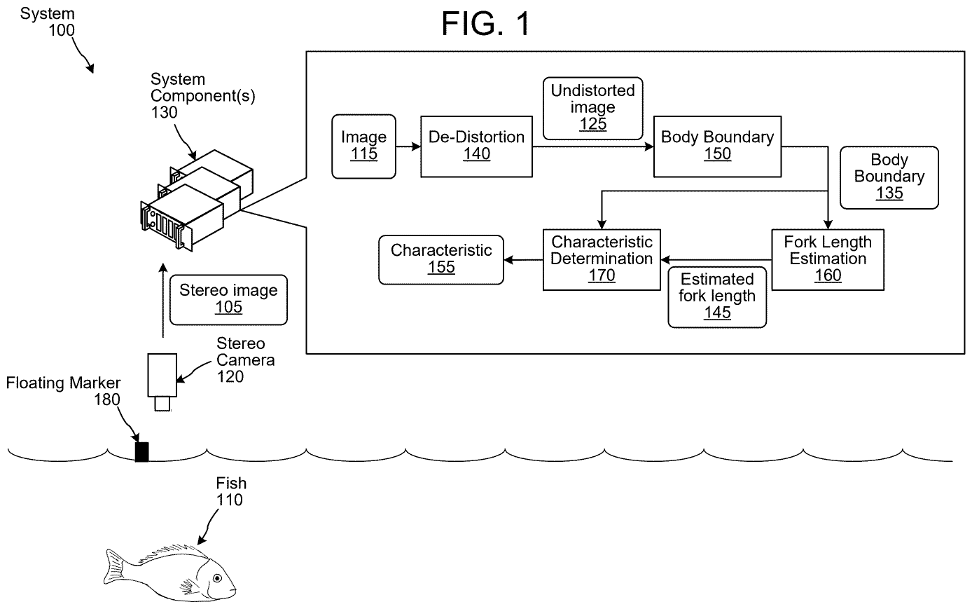

Referring to FIG. 1, one or more fish, collectively illustrated as a fish 110, may be in water. The water may be that of a RAS, dam, pond, lake, and other water having a turbidity not conducive to fish imaging using underwater cameras.

A system 100 for performing top view fish characteristic determination of the present disclosure includes a stereo camera 120 positioned above the water in which the fish 110 is located and a system component(s) 130 in data communication with the stereo camera 120.

The stereo camera 120 may be any commercially available stereo camera. The baseline (i.e., the distance between the two cameras of the stereo camera) may depend on the ceiling height of the enclosure/building in which the stereo camera is installed. As the operating depth range of a stereo camera is dependent on its baseline, shorter ceilings may require a higher baseline, and vice versa.

The stereo camera 120 may be oriented parallel to the water's surface. However, it need not be. In some embodiments, the stereo camera 120 may be offset up to 20° from perpendicular with respect to the water's surface. For example, the stereo camera 120 may be offset 20°, 19°, 18°, 17°, 16°, 15°, 14°, 13°, 12°, 11°, 10°, 9°, 8°, 7°, 6°, 5°, 4°, 3°, 2°, 1°, or 0° from perpendicular with respect to the water's surface.

The system 100 may further include a floating marker 180 positioned above the water within a field of view of the stereo camera 120 and which can be used to determine a distance between the lens of the stereo camera 120 and the water when a stereo image pair is captured. For example, the floating marker 180 may be positioned within a corner of the field of view of the stereo camera 120. The floating marker 180 may be an ArUco marker, which is a 2D binary-encoded fiducial pattern designed to be quickly located by computer vision systems. ArUco marker patterns are defined by a binary dictionary in OpenCV.

The stereo camera 120 may capture a stereo (e.g., left and right) image pair associated with a same timestamp and send corresponding stereo image data 105 to the system component(s) 130. The stereo image data 105 may include left image data corresponding to the left image, right image data corresponding to the right image, distance data indicating a distance of each portion of the left and right image data to the corresponding left and right lens of the stereo camera, and the timestamp of when the left and right images were captured.

The stereo camera 120 may capture stereo image pairs on a periodic basis (e.g., every 1 second, 5 seconds, 10, seconds, 30 seconds, 1 minute, 2 minutes, etc.). Moreover, the stereo camera 120 may capture stereo image pairs for a duration of time (e.g., for 5 minutes, 10 minutes, etc.). In some embodiments, stereo camera 120 may capture stereo image pairs for a duration of time when the fish 110 is expected to be closest to the top of the water. For example, the stereo camera may be configured to capture stereo image pairs during a feeding time of the fish 110. For example, the fish 110 is fed at 5 μm (e.g., a feed dispenser starts dispensing feed at 5 μm), the stereo camera 120 may start capturing stereo image pairs around (e.g., a little prior to, at, or a little after) 5 μm.

In some embodiments, the stereo camera 120 may be in data communication with the system component(s) 130 via a wire. In other embodiments, the stereo camera 120 may send the stereo image data 105 to the system component(s) 130 via one or more networks. The network(s) may include the Internet and/or any other wide- or local-area network, and may include wired, wireless, satellite, and/or cellular network hardware. In some embodiments, the system component(s) 130 may be configured as a cloud computing system.

The system component(s) 130 may include various components such as, for example, a de-distortion component 140, a body boundary component 150, a fork length estimation component 160, and a characteristic determination component 170.

Upon receiving the stereo image data 105, the system component(s) 130 may send image data 115 to the de-distortion component 140, where the image data 115 includes one of the left or right image data of the stereo image data 105. Whether the de-distortion component 140 receives the left image data or right image data is inconsequential.

The de-distortion component 140 generates undistorted image data 125 from the image data 115. Details of processing performable by the de-distortion component 140 are provided herein below.

The undistorted image data 125, corresponding to the (left or right) image data 115, May be input to the body boundary component 150. The body boundary component 150 identifies the body boundaries (excluding the tail portions) of fish in the undistorted image data 125. The body boundary component 150 generates body boundary data 135. The body boundary data 135 may be non-image (e.g., text or tokenized) data indicating corrected stereo camera coordinates (discussed herein below with respect to the de-distortion component 140) corresponding to one or more body boundaries of one or more fish in the undistorted image data 125. Alternatively, the body boundary data 135 may be the undistorted image data 125 with annotations therein defining one or more body boundaries of one or more fish. Details of processing performable by the body boundary component 150 are provided herein below.

The body boundary data 135 may be input to the fork length estimation component 160. The fork length estimation component 160 determines an estimated fork length for each body boundary in the body boundary data 135. Details of processing performable by the fork length estimation component 160 are provided herein below. The fork length estimation component 160 may output estimated fork length data 145 including, for each body boundary in the body boundary data 135, a corresponding corrected estimated fork length (calculation of which is described herein below).

The body boundary data 135 and the estimated fork length data 145 may be input to the characteristic determination component 170. The characteristic determination component 170 may determine at least one characteristic of a fish using the fish's body boundary (from the body boundary data 135) and corresponding corrected estimated fork length (from the estimated fork length data 145).

The characteristic determination component 170 may determine a weight of a fish using the fish's body boundary (from the body boundary data 135) and corresponding corrected estimated fork length (from the estimated fork length data 145). A fork length-to-weight formula may be derived from historical data of fork length and weight. The formula may be used to compute the weight of the fish using the corrected estimated fork length. In some embodiments, the formula may be fish species-specific.

The characteristic determination component 170 may additionally or alternatively determine an overall length of a fish using the fish's body boundary (from the body boundary data 135) and corresponding corrected estimated fork length (from the estimated fork length data 145). For example, the characteristic determination component 170 may determine a body length of the fish as a distance between distal endpoints of the fish's (e.g., linear) body boundary and determine the fish's overall length as a sum of the fish's body length and corrected estimated fork length.

The characteristic determination component 170 may output characteristic data 155 including the one or more characteristics the characteristic determination component 170 determines for each fish. The characteristic data 155 may be used by the system component(s) 130 or another component of the system 100 to estimate a biomass of the fish 110. The biomass estimation may be used to inform fish harvesting timing, among other things.

### De-Distortion Component

The raw feed of the stereo camera 120 may undergo art- and/or industry-known rectification processing to rectify the raw feed. This rectification processing is performed prior to the stereo image data 105 being sent to the system component(s) 130 and is separate from the processing performed by the de-distortion component 140.

For each point in water in the image data 115, the de-distortion component 140 determines a corresponding undistorted point in water for the undistorted image data 125. The de-distortion component 140 may determine an undistorted point in water using a distance between the lens of the stereo camera 120 and the surface of the water at the time the image data 115 was captured and the refractive indexes of air and water.

The image data 115 may include a representation of the floating marker 180 (e.g., in a corner of the image data 115. The de-distortion component 140 may process the image data 115 (and in particular the portion corresponding to the floating marker 180) to determine a distance between the lens of the stereo camera 120 and the top of the water at the time the stereo image pair (resulting in the image data 115) was captured.

The following is example processing of the de-distortion component 140 to determine corrected stereo camera coordinates

$${X}_{rc}^{corr} and {Y}_{rc}^{corr}$$

of an undistorted point P present in water in the image data 115.

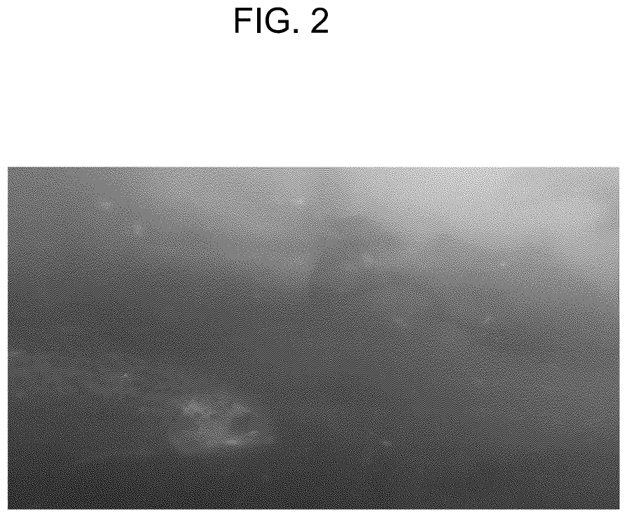

FIG. 2 is an example image, of a stereo image pair, captured using a stereo camera positioned within turbid water with low visibility. Within FIG. 2, the back portion and front portion of two different fish are barely visible.

From FIG. 2, it can be determined that:

$${P}_{c} = \sqrt{{X}_{rc} + {Y}_{rc}} \qquad ( 1 )$$

$${θ}_{diag} = tanh \frac{{P}_{c}}{F} \qquad ( 2 )$$

where X_{rc} and Y_{rc} are camera-coordinate system points of point P in water and F is the distance between the lens of the stereo camera 120 and the water's surface.

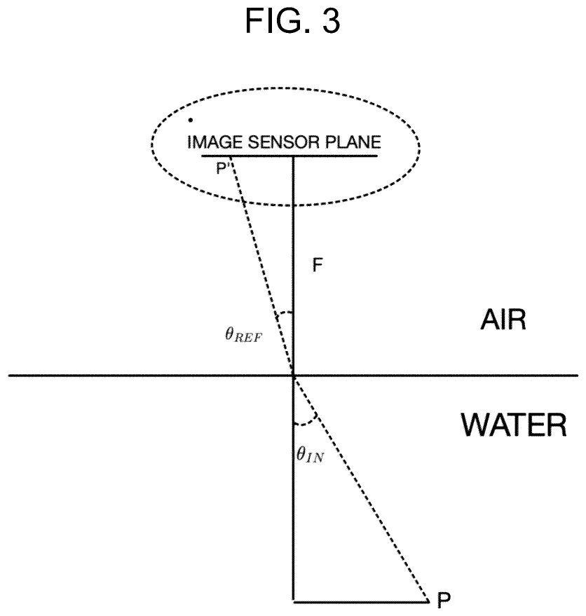

From FIG. 3, it can be determined that:

$$tan {θ}_{REF} = \frac{{P}_{c}}{F} \qquad ( 3 )$$

Setting the refractive index of air n1 as 1 and water n2 as 1.33 and using Snell's law:

$${θ}_{REF} = sinh \frac{n 2}{n 1} sin {θ}_{IN} \qquad ( 4 )$$

For an ideal scenario, where refraction does not exist it may be desired:

$${θ}_{REF} = {θ}_{IN} \qquad ( 5 )$$

Therefore, using Equations 3 and 4:

$$\frac{{P}_{c}^{corr}}{F} = {θ}_{IN} \qquad ( 6 )$$

$${X}_{rc}^{corr} = cos {θ}_{diag} * {P}_{c}^{corr} \qquad ( 7 )$$

$${Y}_{rc}^{corr} = sin {θ}_{diag} * {P}_{c}^{corr} \qquad ( 8 )$$

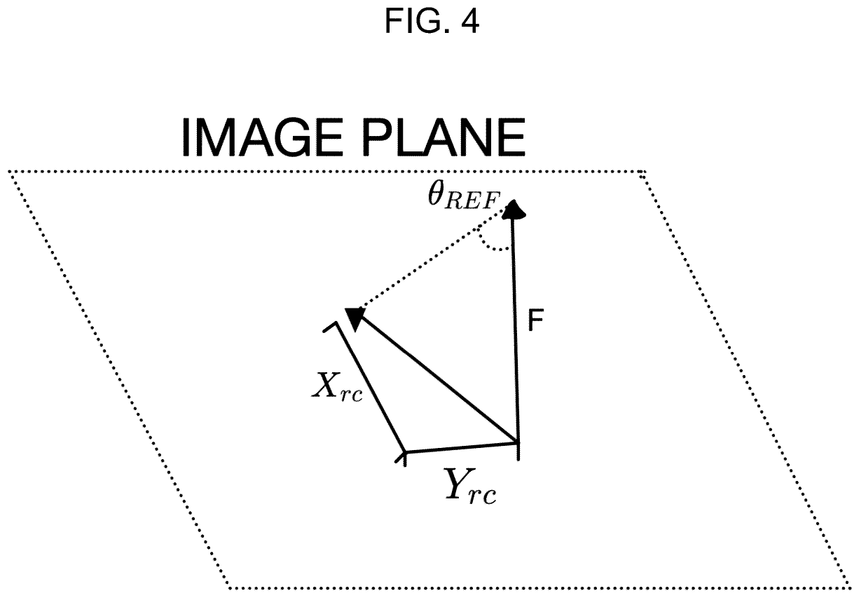

FIG. 4 illustrates stereo camera coordinates X_{rc} and Y_{rc} (i.e.,

$${X}_{rc}^{corr} and {Y}_{rc}^{corr}$$

of point P after refraction is accounted for.

After undistorting the left and right image data, the de-distortion component 140 may determine a disparity map and, subsequently, the depth at the corrected stereo camera-coordinate values. In some embodiments, the de-distortion component 140 may do this using a Semi-Global Block Matching (SGBM) algorithm, which uses block-based cost matching that is smoothed by path-wise information from multiple directions. An example SGBM algorithm that may be used is described in H. Hirschmuller, “Accurate and efficient stereo processing by semi-global matching and mutual information,” 2005 IEEE Computer Society Conference on Computer Vision and Pattern Recognition (CVPR'05), San Diego, CA, USA, 2005, pp. 807-814 vol. 2, doi: 10.1109/CVPR.2005.56, which is incorporated here by reference in its entirety.

The de-distortion component 140 may perform the forgoing processing for each X_{rc} and Y_{rc} coordinate pair in the image data 115.

### Body Boundary Component

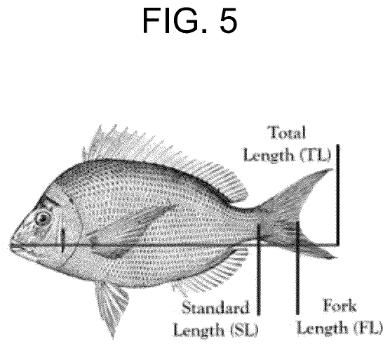

FIG. 5 is a side view of a fish illustrating the fish's standard length (SL), fork length (FL), and total length (TL). In FIG. 5, the standard length is measured from the fish's nose tip to the standard length line, the fork length is measured from the standard length line to the fork length line (e.g., the midsection of the tail section curvature), and the total length is measured from the fish's nose tip to the total length line.

The body boundary component 150 may implement a trained machine learning (ML) model configured to take as input the undistorted image data 125 and output the body boundary data 135. The ML model may be trained using supervised learning.

For training, the left or right image data (of a stereo image pair) may be manually annotated to define a “visible” boundary annotation mask of the bodies of one or more fish in the image data. Whether the left or right image data is used is only consequential to the point that is corresponds to whether the left or right image data is input to the body boundary component 150 at runtime.

A set A, from image data collected over multiple days, and may annotated to create a training set to train the supervised ML (e.g., segmentation) model so the model can predict top view body boundaries on unseen data. In some embodiments, the set of training image data may be selected to be only image data where the tip of the dorsal fin of a fish is no father than a threshold distance (e.g., 10 cm) below the water's surface. The distance of the dorsal fin to the water's surface may be determined using a floating marker as described herein above. Once a candidate fish is identified, the boundary edges separating the water from the fish's body (excluding the tail portion) may be manually annotated.

In some embodiments, the Mask-RCNN official repository segmentation model may be used and trained with an 80-20 train-test split with two classes (i.e., “fish” and “no fish”).

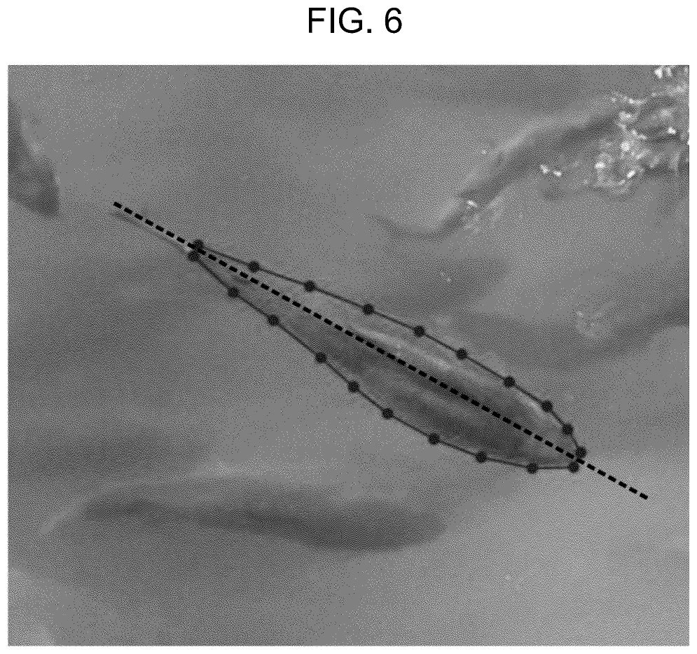

The ML model of the body boundary component 150 may be trained to first identify one or more fish in input image data and second, for each identified fish, generate body boundary data. The body boundary data may be non-image (e.g., text or tokenized) data indicating corrected stereo camera coordinates (discussed herein below with respect to the de-distortion component 140) corresponding to the body boundary of an identified fish in the input image data. Alternatively, the body boundary data may be the input image data with annotations defining the body boundary of the identified fish. FIG. 6 is an example of body boundary data in the form of input image data with annotations defining the body boundary of an identified fish.

### Fork Length Estimation Component

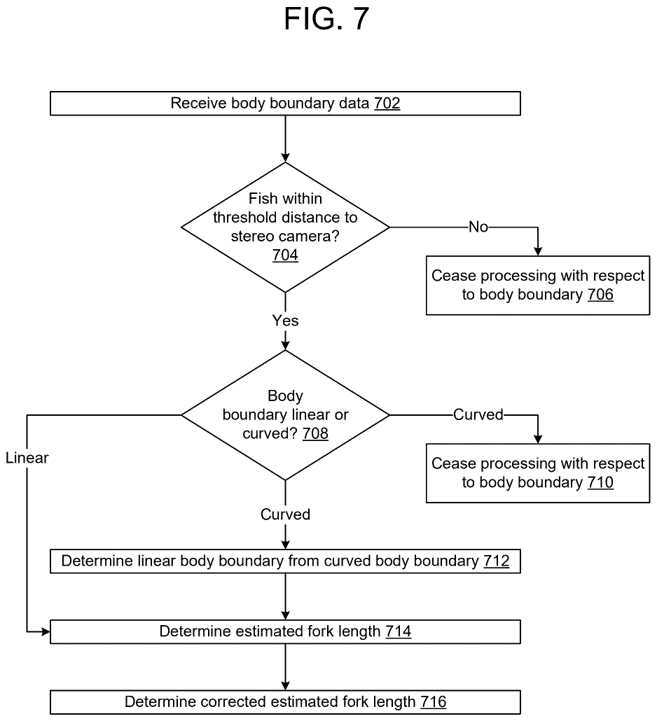

FIG. 7 illustrates an example method performable by the fork length estimation component 160. The fork length estimation component 160 may perform the method of FIG. 7 with respect to each separate body boundary included in received body boundary data.

Even though the body boundary data may be generated from undistorted image data 125, there may still be a depth limit at which estimating a fork length becomes difficult and unreliable. Due to this and with reference to FIG. 7, upon receiving (step 702) body boundary data, the fork length estimation component 160 may determine (step 704) whether the fish (corresponding to the body boundary being processed) is within a threshold distance to the (e.g., lens) of the stereo camera 120. As discussed above, each pair of corrected stereo camera coordinates

$${X}_{rc}^{corr} and {Y}_{rc}^{corr}$$

may have associated distance data indicating a distance from the (e.g., lens) of the stereo camera 120 to the point corresponding to the

$${X}_{rc}^{corr} and {Y}_{rc}^{corr}$$

pair. This distance information may be included in the body boundary data received by the fork length estimation component 160. When it is, the fork length estimation component 160 may determine a shortest distance contained with the body boundary being processed and determine whether the shortest distance is no farther than a threshold distance. This determination may effectively determine whether the tip of the dorsal fin of the fish (bounded by the body boundary) is no farther than a threshold distance away from the (e.g., lens) of the stereo camera 120. By making this determination that the tip of the dorsal fin of the fish is above or below the water's surface but in any event no farther than the threshold distance, the fork length estimation component 160 may improve the likelihood of fork length estimation processes being sufficiently accurate.

The threshold distance is configurable. In some embodiments, the threshold distance may be no more than 10 cm. For example, the threshold distance may be 1 cm, 2 cm, 3 cm, 4 cm, 5 cm, 6 cm, 7 cm, 8 cm, 9 cm, or 10 cm.

If the fork length estimation component 160 determines the fish is not within the threshold distance to the (e.g., lens) of the stereo camera 120, the fork length estimation component 160 may cease (step 706) processing with respect to the body boundary. In other words, the fork length estimation component 160 may refrain from determining an estimated fork length based on the body boundary.

As the stereo camera 120 is positioned above the water, a fish within the water may have a linear or curved orientation when the stereo camera 120 captured a stereo image pair. By extension, the body boundary data for a fish may have a linear or curved orientation.

After determining the fish is within the threshold distance to the (e.g., lens) of the stereo camera 120 or simply after receiving the body boundary data (in embodiments where the fork length estimation component 160 is not configured to perform the threshold distance filtering of step 704), the fork length estimation component 160 may determine (step 708) whether the body boundary is in a linear or curved orientation. If the body boundary is in the curved orientation, the fork length estimation component 160 may perform one or two operations, depending on configuration of the fork length estimation component 160. In some embodiments, upon determining the body boundary is curved, the fork length estimation component 160 may cease (step 710) processing with respect to the body boundary. In other words, the fork length estimation component 160 may refrain from determining an estimated fork length based on the body boundary.

Alternatively, upon determining the body boundary is curved, the fork length estimation component 160 may determine (step 712) a linear body boundary from the curved body boundary. In other words, the fork length estimation component 160 may determine a linear orientation for the fish. In some embodiments, the curved-to-linear transformation may be derived using piecewise linearization. After determining the data points of the curved body boundary, the fork length estimation component 160 may sample multiple points in between the data points to get multiple line segments. When added, the line segments may be considered an approximate linear (i.e., straight line) length of the curve.

From the linear orientation of the fish (i.e., the linear body boundary determined at step 708 or 712), the fork length estimation component 160 may determine (step 714) an estimated fork length L_{P} of the fish. The fork length estimation component 160 may determine the distal endpoints of the linear body boundary and determine the estimated fork length using the distal endpoints. For example, the fork length estimation component 160 may determine a distance between the distal endpoints (e.g., by determining a distance between the corrected stereo camera coordinates

$${X}_{rc}^{corr} and {Y}_{rc}^{corr}$$

of the distal endpoints) and may determine the estimated fork length using the distance. In some embodiments, determining the distance between the distal endpoints may include determining a minimum area rectangle that encloses the determined body boundary, with the distance between the distal endpoints being measured between the midpoints of the smallest two sides of the rectangle.

The fork length estimation component 160 may determine the estimated fork length based on the distance between the distal endpoints. For example, the fork length estimation component 160 may store or have access to a storage of data including fish body lengths associated with corresponding fork lengths. The stored data may be based on real world measurements of fish body lengths and corresponding fork lengths.

In some embodiments, the fork length estimation component 160 may determine the estimated fork length based on the distance between the distal endpoints and the species of the fish. For example, the fork length estimation component 160 may store or have access to a storage of data including fish body lengths associated with corresponding fish species and fork lengths. The stored data may be based on real world measurements of fish body lengths and corresponding fork lengths.

The fork length estimation component 160 may determine (step 716) a corrected estimated fork length using the estimated fork length and a length factor. The following describes how a length factor Of may be computed using a corrected estimated fork length

$${L}_{P}^{C}$$

(determined using the techniques described herein) and a true fork length L_{T} measured for the fish for which the corrected estimated fork length was computed. The relationship between the corrected estimated fork length

$${L}_{P}^{C} ,$$

length factor δf, and true fork length L_{T} may be represented as:

$${L}_{P}^{C} + δ f \approx {L}_{T} \qquad ( 9 )$$

The length factor may be a species-specific length factor. A species-specific length factor may be determined as follows. Side and top view images of different sized fish of a same species in a tank may be captured. Thereafter, the side view images may undergo manual annotation to indicate the true fork length. The fish may also be weighed to obtain their masses.

The generic length-weight formula using side view fork length may be represented as:

$$W = a * {( {L}_{T} )}^{b} \qquad ( 10 )$$

where a and b are obtained by curve-fitting on historical data. Plugging Equation 9 into Equation 10, the following is obtained:

$$W = a * {( {L}_{P}^{C} + δ f )}^{b} \qquad ( 11 )$$

The objective function, which is to be minimized, is the sum of the squared differences between the observed values W, which are the actual weight, and the predicted weight values W′ obtained using estimated fork length:

$$S ( δ f ) = {\sum }_{i = 1}^{N} {( {W}_{i} - {W}_{i}^{′} )}^{2} \qquad ( 12 )$$

where N is the number of data points obtained from multiple fish in the tank.

$${W}_{i}^{′} = a * {( {Lt}_{i} + {δ}_{f} )}^{b} \qquad ( 13 )$$

The length factor for the fish species can then be determined by optimizing for &f using least squares optimization (e.g., using an optimize module in scipy library for python).

### System Component(s)

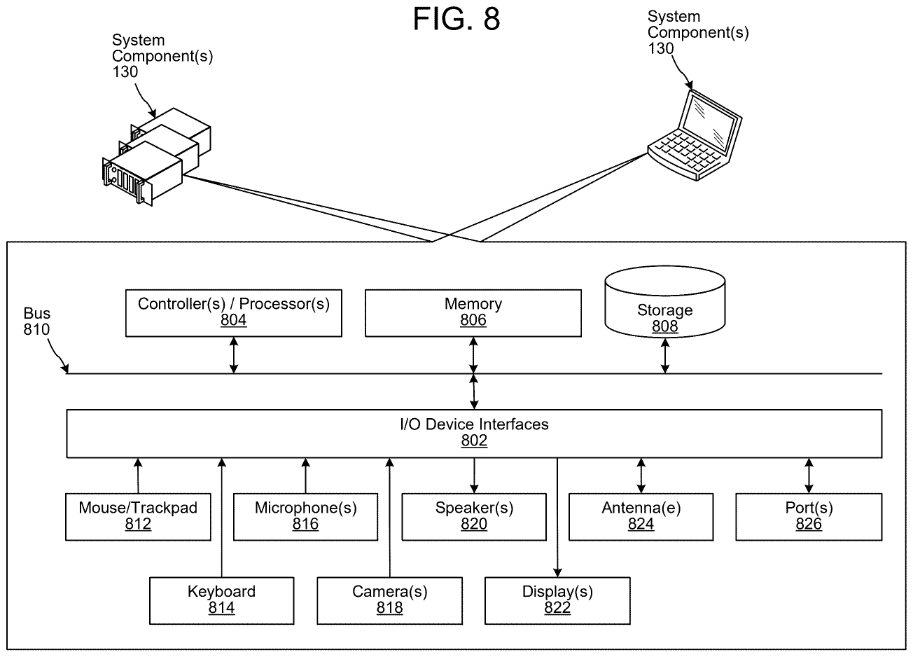

FIG. 8 is a block diagram conceptually illustrating example components of the system component(s) 130. The system component(s) 130 may be a single or multiple computing devices that operate alone or together to perform the processing described herein. For example, the system component(s) 130 could be a single or multiple servers. For further example, the system component(s) 130 could be a laptop, smart phone, tablet, Internet of Things (IoT) device, or some other “user” device capable of performing the processing described herein. As another example, the system component(s) 130 may be a communications hub (placed on land) configured to receive the data from the stereo camera 120 and send the data to another system component (e.g., via a wire or one or more cellular or satellite networks) that performs the processing herein.

A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulate a computer system and is run on one or across multiple devices. A server may also include other combinations of hardware, software, firmware, or the like to perform operations discussed herein. The system component(s) 130 may be configured to operate using one or more of a client-server model, a computer bureau model, grid computing techniques, fog computing techniques, mainframe techniques, utility computing techniques, a peer-to-peer model, sandbox techniques, or other computing techniques.

The system component(s) 130 may include a controller(s)/processor(s) 804, which may each include a central processing unit (CPU) for processing data and computer-readable instructions, and a memory 806 for storing data and instructions. The memory 806 may include volatile random access memory (RAM), non-volatile read only memory (ROM), non-volatile magnetoresistive memory (MRAM), and/or other types of memory. The system component(s) 130 may also include a data storage 808 for storing data and controller/processor-executable instructions. The data storage 808 may include one or more non-volatile storage types such as magnetic storage, optical storage, solid-state storage, etc. The system component(s) 130 may also be connected to removable or external non-volatile memory and/or storage (such as a removable memory card, memory key drive, networked storage, etc.) through respective input/output device interfaces 802.

Computer instructions for operating the system component(s) 130 and its various components may be executed by the controller(s)/processor(s) 804, using the memory 806 as temporary “working” storage at runtime. The computer instructions of the system component(s) 130 may be stored in a non-transitory manner in the memory 806, data storage 808, or an external device(s). Alternatively, some or all of the executable instructions may be embedded in hardware or firmware in addition to or instead of software.

The system component(s) 130 may include input/output device interfaces 802. A variety of components may be connected through the input/output device interfaces 802, as will be discussed further below. Additionally, the system component(s) 130 may include an address/data bus 810 for conveying data among components of the system component(s) 130. Each component within the system component(s) 130 may also be directly connected to other components in addition to (or instead of) being connected to other components across the address/data bus 810.

The input/output device interfaces 802 may connect to a variety of components such as, but not limited to, a mouse and/or trackpad 812, a keyboard 814, one or more microphones 816, one or more cameras 818, one or more speakers 820, one or more displays 822, one or more antennae 824 (for connecting to one or more networks), and one or more ports 826 for connecting the system component(s) 130 to an external device via a wire.

Via the one or more antennae 824, the input/output device interfaces 802 may connect to one or more networks via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. The input/output device interfaces 802 may also include communication components that allow data to be exchanged between devices, such as different physical servers in a collection of servers or other components.

As noted above, multiple devices may be employed in the system component(s) 130. In such a multi-device system, each of the devices may include different components for performing different aspects of the system's processing. The multiple devices may include overlapping components.

The concepts disclosed herein may be applied within a number of different devices and computer systems, including, for example, general-purpose computing systems, speech processing systems, and distributed computing environments.

### Further Definitions

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the art should recognize that components and process steps described herein may be interchangeable with other components or steps, or combinations of components or steps, and still achieve the benefits and advantages of the present disclosure. Moreover, it should be apparent, to one skilled in the art, that the disclosure may be practiced without some or all of the specific details and steps disclosed herein.

Aspects of the disclosure may be implemented as a computer-implemented method or as an article of manufacture such as a memory device or non-transitory computer readable storage medium. The computer readable storage medium may be readable by a computer and may comprise instructions for causing a computer to perform processes described in the present disclosure. The computer readable storage medium may be implemented by a volatile computer memory, non-volatile computer memory, hard drive, solid-state memory, flash drive, removable disk, and/or other media. In addition, components of system may be implemented in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments. The terms “comprising,” “including,” “having,” and the like are synonymous and are used inclusively, in an open-ended fashion, and do not exclude additional elements, features, acts, operations, and so forth.

Disjunctive language such as the phrase “at least one of X, Y, Z,” unless specifically stated otherwise, is understood with the context as used in general to present that an item, term, etc., may be either X, Y, or Z, or any combination thereof, e.g., X, Y, and/or Z. Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

1. A system comprising:
at least one processor; and
at least one memory comprising instructions that, when executed by the at least one processor, cause the system to:
receive image data from a stereo camera positioned above water, the image data comprising left image data and right image data associated with a same timestamp;
determine undistorted image data from one of the left or right image data;
determine a body boundary of a fish in the undistorted image data, the body boundary excluding a tail portion of the fish;
determine, using the body boundary, an estimated fork length of the fish; and
determine at least one characteristic of the fish using the body boundary and the estimated fork length.

2. The system of claim 1, wherein a lens of the stereo camera is oriented parallel to a surface of the water.

3. The system of claim 1, wherein a lens of the stereo camera is offset up to 20° from perpendicular with respect to a surface of the water.

4. The system of claim 1, wherein the image data is captured during a feeding time of fish in the water.

5. The system of claim 1, wherein the at least one memory further comprises instructions that, when executed by the at least one processor, cause the system to determine the undistorted image data by, for each coordinate pair in one of the left or right image data, determine a corrected coordinate pair using a distance between a lens of the stereo camera and a surface of the water, the refractive index of air, and the refractive index of water.

6. The system of claim 1, wherein the at least one memory further comprises instructions that, when executed by the at least one processor, cause the system to:
determine, using the body boundary, that the fish has a linear orientation; and
determine the estimated fork length based on the fish having the linear orientation.

7. The system of claim 1, wherein the at least one memory further comprises instructions that, when executed by the at least one processor, cause the system to:
determine a second body boundary of a second fish in the undistorted image data, the second body boundary excluding a tail portion of the second fish;
determine, using the second body boundary, that the second fish has a curved orientation; and
refrain from determining a second estimated fork length for the second fish based on the second fish having the curved orientation.

8. The system of claim 1, wherein the at least one memory further comprises instructions that, when executed by the at least one processor, cause the system to:
determine, using the body boundary, that the fish has a curved orientation;
after determining the fish has a curved orientation, determine a linear orientation for the fish; and
determine the estimated fork length using the linear orientation.

9. The system of claim 1, wherein the at least one memory further comprises instructions that, when executed by the at least one processor, cause the system to:
determine distal endpoints of the body boundary; and
determine the estimated fork length using the distal endpoints.

10. The system of claim 1, wherein the at least one memory further comprises instructions that, when executed by the at least one processor, cause the system to:
determine a corrected estimated fork length using the estimated fork length and a length factor; and
determine the at least one characteristic of the fish using the body boundary and the corrected estimated fork length.

11. The system of claim 10, wherein the length factor is selected based on a species of the fish.

12. The system of claim 10, wherein the at least one memory further comprises instructions that, when executed by the at least one processor, cause the system to determine the length factor based on corresponding side view and top view image data of a plurality of fish corresponding to a same species.

13. The system of claim 1, wherein the at least one memory further comprises instructions that, when executed by the at least one processor, cause the system to:
determine, within the body boundary, a portion of the fish having a shortest distance to the stereo camera;
determine the shortest distance is no farther than a threshold distance; and
determine the estimated fork length in response to the shortest distance being no farther than the threshold distance.

14. The system of claim 13, wherein the threshold distance is 10 cm.

15. The system of claim 1, wherein the at least one characteristic comprises at least one of a weight and an overall length of the fish.

16. A device comprising:
at least one processor; and
at least one memory comprising instructions that, when executed by the at least one processor, cause the device to:
receive image data from a stereo camera positioned above water, the image data comprising left image data and right image data associated with a same timestamp;
determine undistorted image data from one of the left or right image data;
determine a body boundary of a fish in the undistorted image data, the body boundary excluding a tail portion of the fish;
determine, using the body boundary, an estimated fork length of the fish; and
determine at least one characteristic of the fish using the body boundary and the estimated fork length.

17-19. (canceled)

20. The device of claim 16, wherein the at least one memory further comprises instructions that, when executed by the at least one processor, cause the device to determine the undistorted image data by, for each coordinate pair in one of the left or right image data, determine a corrected coordinate pair using a distance between a lens of the stereo camera and a surface of the water, the refractive index of air, and the refractive index of water.

21. (canceled)

22. The device of claim 16, wherein the at least one memory further comprises instructions that, when executed by the at least one processor, cause the device to:
determine a second body boundary of a second fish in the undistorted image data, the second body boundary excluding a tail portion of the second fish;
determine, using the second body boundary, that the second fish has a curved orientation; and
refrain from determining a second estimated fork length for the second fish based on the second fish having the curved orientation.

23. The device of claim 16, wherein the at least one memory further comprises instructions that, when executed by the at least one processor, cause the device to:
determine, using the body boundary, that the fish has a curved orientation;
after determining the fish has a curved orientation, determine a linear orientation for the fish; and
determine the estimated fork length using the linear orientation.

24-30. (canceled)

31. A computer-implemented method comprising:
receiving image data from a stereo camera positioned above water, the image data comprising left image data and right image data associated with a same timestamp;
determining undistorted image data from one of the left or right image data;
determining a body boundary of a fish in the undistorted image data, the body boundary excluding a tail portion of the fish;
determining, using the body boundary, an estimated fork length of the fish; and
determining at least one characteristic of the fish using the body boundary and the estimated fork length.

32-45. (canceled)
